(19) United States
(12) Patent Application Publication
(10) Pub. No.: US 2015/0333492 A1
(43) Pub. Date: Nov. 19, 2015

(54) Stripped Wire Insulation Retainer

(71) Applicant: James Campbell, Modesto, CA (US)

(72) Inventor: James Campbell, Modesto, CA (US)

(21) Appl. No.: 14/704,894

(22) Filed: May 5, 2015

Related U.S. Application Data
(60) Provisional application No. 61/992,632, filed on May 13, 2014.

(51) Int. Cl. H02G 1/12

(52) U.S. Cl. CPC H02G 1/1209

(57) ABSTRACT

An attachment for a wire stripper is disclosed. The attachment is securable to a wire stripper and provides a compartment for retaining stripped insulation. The insulation retainer is specifically designed to attach to a particular type/style of wire stripper, but could essentially be designed and configured to fit or adapt on nearly any type of wire stripper, The insulation retainer is temporally retained on the wire stripper with a fastener, clip, magnet or other fastening means where the insulation retainer is installed, removed, and moved as desired. The chamber is configured to allow unstripped wire to be easily placed into the chamber and still retain stripped wire with minimal or no risk of the stripped insulation from falling out of the retaining compartment. When the insulation is stored all of the pieces can be collectively discharged in the trash or in a recycling container.

### CROSS REFERENCE TO RELATED APPLICATION

This application claims the benefit of Provisional Application Ser. No. 61/992,632 filed May 13, 2014 the entire contents of which is hereby expressly incorporated by reference herein.

### STATEMENT REGARDING FEDERALLY SPONSORED RESEARCH OR DEVELOPMENT

Not Applicable

### THE NAMES OF THE PARTIES TO A JOINT RESEARCH AGREEMENT

Not Applicable

### INCORPORATION-BY-REFERENCE OF MATERIAL SUBMITTED ON A COMPACT DISC

Not Applicable

### BACKGROUND OF THE INVENTION

1. Field of the Invention

This invention relates to improvements in an insulation retainer for a wire stripper. More particularly, the present insulation retainer for a wire stripper is an attachment device that is removably attachable to a wire stripper to retain stripped insulation that is removed from insulated wire.

2. Description of Related Art Including Information Disclosed Under 37 CFR 1.97 and 1.98:

Many types of wire are fabricated with an insulation jacket that surrounds the conducting wire, wires or a collection of wire or wires. The insulation prevents conductivity between the wire conductor and other wires or conductive surface. In order to connect the conductor to a desired connection a portion of the insulation must be removed or stripped. Typically when the insulation from jacketed wire is stripped the removed insulation is discarded on a floor or desk. The removal of the insulation is typically swept onto the ground where it can be further swept together and collected for disposal. The collection of the discarded insulation requires additional time and expense that can be avoided if the stripped insulation can be collected when it is stripped from the conductor.

A number of patents and or publications have been made to address these issues. Exemplary examples of patents and or publication that try to address this/these problem(s) are identified and discussed below.

There are a number of different types of wire strippers that strip a particular gauge of wire or multiple gauges of wire. A good example of this type of wire strippers is found in U.S. Pat. No. 3,654,647 that issued on Apr. 11, 1972 for Ted Neff. The disclosed tool has the form of pliers with a plurality of holes for different gauges of wire. A user places a jacketed wire in the stripping hole that corresponds to the particular gauge of wire, squeezes the tool to cut through the insulation and then pulls on the jacketed wire to remove a portion of the insulation from the end of the wire to expose an un-insulated section of wire. There is no mechanism to capture the stripped insulation for later disposal.

There are many wire strippers that remove the insulation jacket from a wire. One type of stripper strips and retains the insulation on the conductor. One example is found in U.S. Pat. No. 2,523,936 that issued on Sep. 26, 1950 to Howard C. Axelson. While this method stripping the insulation from the wire does not completely discharge the insulation from the wire, the insulation is not collected and can ultimately fall to the ground.

Another example is found in U.S. Pat. No. 3,002,407 issued on Oct. 3, 1961 for C. C. Johnson discloses a Wire Stripping Tool with a chamber for retaining stripped insulation. While this patent discloses a wire stripper that holds stripped insulation, the retention compartment must be opened every time a user inserts an unstripped wire into the tool. Further, the retention device is an integral part of the tool and is not removable for use on other tool.

What is needed is an adapter that is removable connectable onto a pre-existing wire stripper. The adapter prevents stripped insulation from falling from the stripper and collects a plurality of stripped insulation until the user removed the adapter for disposal of the stripped insulation in a trash can or recycling container.

### BRIEF SUMMARY OF THE INVENTION

It is an object of the insulation retainer for a wire stripper to be temporally securable to a pre-existing wire stripping tool. There are many different types of wire strippers. The insulation retainer is specifically designed to attach to a particular type/style of wire stripper, but could essentially be designed and configured to fit or adapt on nearly any type of wire stripper. The insulation retainer is temporally retained on the wire stripper with a fastener, clip, magnet or other fastening means where the insulation retainer is installed, removed, and moved as desired.

It is an object of the insulation retainer for a wire stripper to hold stripped insulation in a chamber. The chamber can essentially be configured to nearly any internal volume to hold minutes worth of stripping to an entire day of stripping wire. The chamber is configured to allow unstripped wire to be easily placed into the chamber and still retain stripped wire with minimal or no risk of the stripped insulation from falling out of the retaining compartment.

It is an object of the insulation retainer for a wire stripper to be fabricated from a light weight material. The light weight material is preferably plastic and can be printed molded or machined to the desired shape to provide the desired configuration for a wire stripper. The light weight material does not add significant weight to the wire strippers that would increase fatigue for the operator.

It is another object of the insulation retainer for a wire stripper to retain the stripped insulation until the insulation pieces can be collectively discarded. Stripping the insulation of wire often ends with an abrupt action where the insulation can be thrown a distance from where the wire is stripped. This leaves a scattering of insulation pieces spread over a wide area making cleaning of the floor more time consuming. When the insulation is stored all of the pieces can be collectively discharged in the trash or in a recycling container.

It is another object of the insulation retainer for the retainer to provide a finite depth that can be used as a stripping gauge whereby a user can push the jacketed wire into the bottom of the retainer, close the stripper and pull on the insulated wire. This essentially ensures that all of the stripped wired has approximately the same conducting length. The retainer can be designed for a particular depth to set the strip length. Typically the conductor strip length for a house is all the same thereby the retainer can be designed for the optimal conductor stripped length.

It is another object of the insulation retainer for the retainer to reduce or prevent Foreign Object Debris (FOD) from contaminating a work area. Loose wire remnants and insulation is considered FOD and the nonprofit organization NAFPI is a nonpartisan association of people and organizations from many different areas of the aerospace industry (including military, commercial, airline, manufacturing, airports and support industries). This group recognizes the serious negative impact of FOD has on safety and fiscal responsibility and is committed to a common goal to educate, create awareness, and promote FOD prevention in all aspects of aerospace operations and manufacturing. The prevention of FOD from forming is easier than collecting FOD after it is created from wire cutting and stripping.

It is still another object of the insulation retainer for a wire stripper to collect all of the insulation from different gauges of wire. Most wire strippers are sized to strip a variety of different gauges of wire and retain the various different pieces of insulation. Insulation can also vary for the same gauge and the length of the stripped insulation can also vary.

Various objects, features, aspects, and advantages of the present invention will become more apparent from the following detailed description of preferred embodiments of the invention, along with the accompanying drawings in which like numerals represent like components.

### BRIEF DESCRIPTION OF THE SEVERAL VIEWS OF THE DRAWING(S)

FIG. 1 shows a side view of an insulation retainer for a wire stripper on a wire stripper tool.

FIG. 2 shows a side view sectional view of an insulation retainer for a wire stripper on a wire stripper tool with a wire being stripped.

FIG. 3 shows a back side view of an insulation retainer for a wire stripper on a wire stripper tool.

FIG. 4 shows a front side view of an insulation retainer for a wire stripper on a wire stripper tool.

FIG. 5 shows a front side view of an insulation retainer for a wire stripper on a wire stripper tool rotated to allow for endless stripping.

FIG. 6 shows a front side view of an insulation retainer for a wire stripper on a wire stripper tool with the door opened to empty stripped wire insulation.

FIG. 7 shows an outside view of the door.

FIG. 8 shows an inside view of the door.

FIG. 9 shows an outside view of the cover.

FIG. 10 shows an inside view of the cover.

FIG. 11 shows a view of an alternate embodiment on a wire stripper tool that strip wire from the middle of the tool.

FIG. 12 shows a rotated view of alternate embodiment shown in FIG. 11 with the tool and the cover removed.

### DETAILED DESCRIPTION OF THE INVENTION

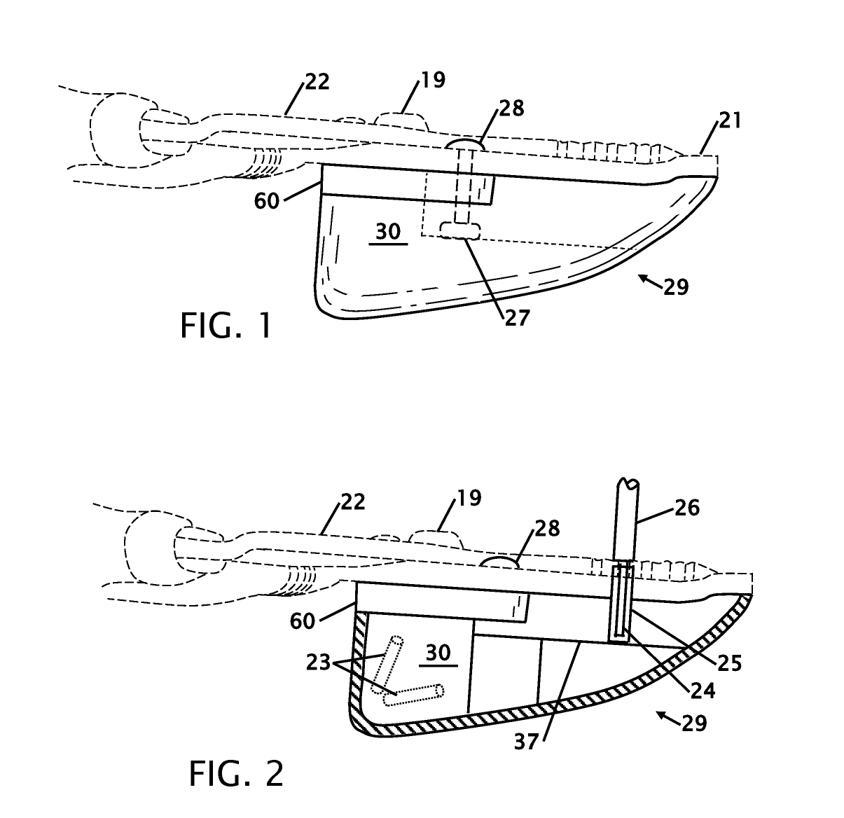

FIG. 1 shows a side view of an insulation retainer for a wire stripper 29 on a wire stripper tool. A typical wire stripping tool is essentially constructed similar to a pair of pliers fabricated from two formed sheets 21, 22 that are joined with a rivet 19, screw of similar fastener. The wire strippers have one or a plurality of slots that grasp the jacket of a wire to remove the insulation. The stripped insulation retainer 29 mounts to the wire stripper by passing a screw 28 through one of the sides 21 of the stripping tool. The screw passes through a door component 60 and then through the cover 30 where the two components are retained with a nut 27. The stripped insulation retainer 29 can be easily installed and removed from wire strippers, and can be configured to fit and conform to wire strippers. While the design shown and described in the document describes retaining stripped insulation, it could be equally configured for wire cutters or trimmers where the trimmed piece would normally fall from the cutter.

FIG. 2 shows a side view sectional view of an insulation retainer for a wire stripper on a wire stripper tool with a wire being stripped. This figure shows an insulated wire 26 gripped by the stripper tool. The wire 26 is shown being placed on an internal ledge 37 that strips about ½ inch of insulation from the wire 26. For longer strip lengths the end of the wire can be pushed past the ledge 37, or the stripped insulation retainer 29 can be rotated to allow for stripping a nearly infinite length of wire. If a user wants to strip a shorter length, the operator does not push the insulated wire 26 completely to the ledge 37. Once the wire stripper is closed the insulation jacket 25 is pinched from the wire 24. The removed piece of insulation 23 can then move into a storage area of the housing of the stripped insulation retainer 29. The stripped insulation pieces 23 collect in the stripped insulation retainer 29 until it is emptied (as shown and described later herein).

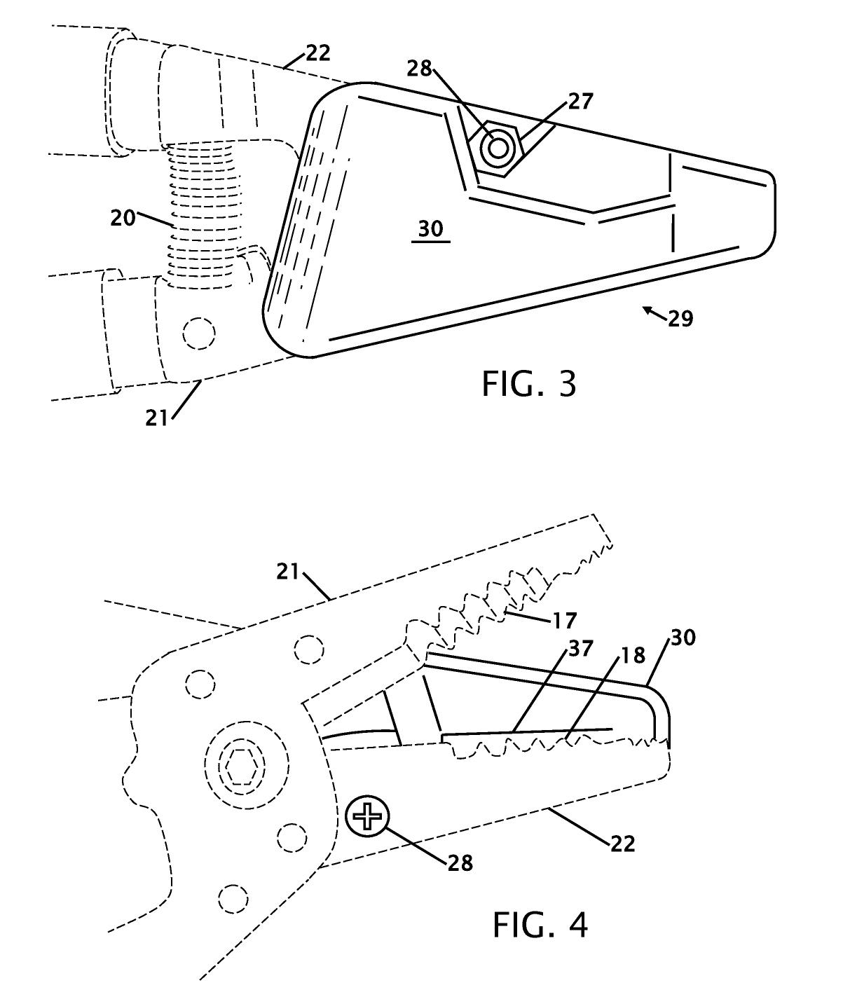

FIG. 3 shows a back side view of an insulation retainer for a wire stripper on a wire stripper tool 29. This view shows the back surface of the stripped insulation retainer 29 with the housing 30 and the nut 27 and screw 28 engaged into the nut 27. Both sides of the 21 and 22 of the stripper tool are visible with a spring 20 that opens the wire stripper to make it easier to repeatedly install sequential insulated wires onto the stripped insulation retainer 29.

FIG. 4 shows a front side view of an insulation retainer 29 for a wire stripper on a wire stripper tool. This image is a flipped (tool) version from the previous view. In this view the jaws 21 and 22 of the wire stripper are shown opened. The housing 30 of the stripped insulation retainer 29 is visible. This is a typical view where a jacketed wire is inserted between the slot(s) 17 of the wire stripper. The ledge 37 is visible in this figure and provides a slight overlap from the position of the strip teeth. The overlap allows an operator to easily set the end of the insulated jacket onto the ledge 37, and the overlap is not so significant that an operator can't slide the insulated wire past the ledge to strip a longer length of wire. While the ledge is shown and described at a specific depth of ½ inch it is contemplated that the ledge 37 could be at a different depth or there could be multiple ledges at different depths.

FIG. 5 shows a front side view of an insulation retainer for a wire stripper on a wire stripper tool rotated to allow for endless stripping. The shell housing 30 and the cover 60 are rotated together through the pivot created by screw 28. A lock 18 prevents the wire stripper from being opened. In this rotation longer lengths of wire can be stripped because the stripped insulation retainer 29 is rotated out of a position where it will interfere with wire being stripped. Any stripped insulation will fall after being stripped. Collected insulation will be retained in the stripped insulation retainer 29, and the insulation pieces are typically retained in the reservoir under the cover 60.

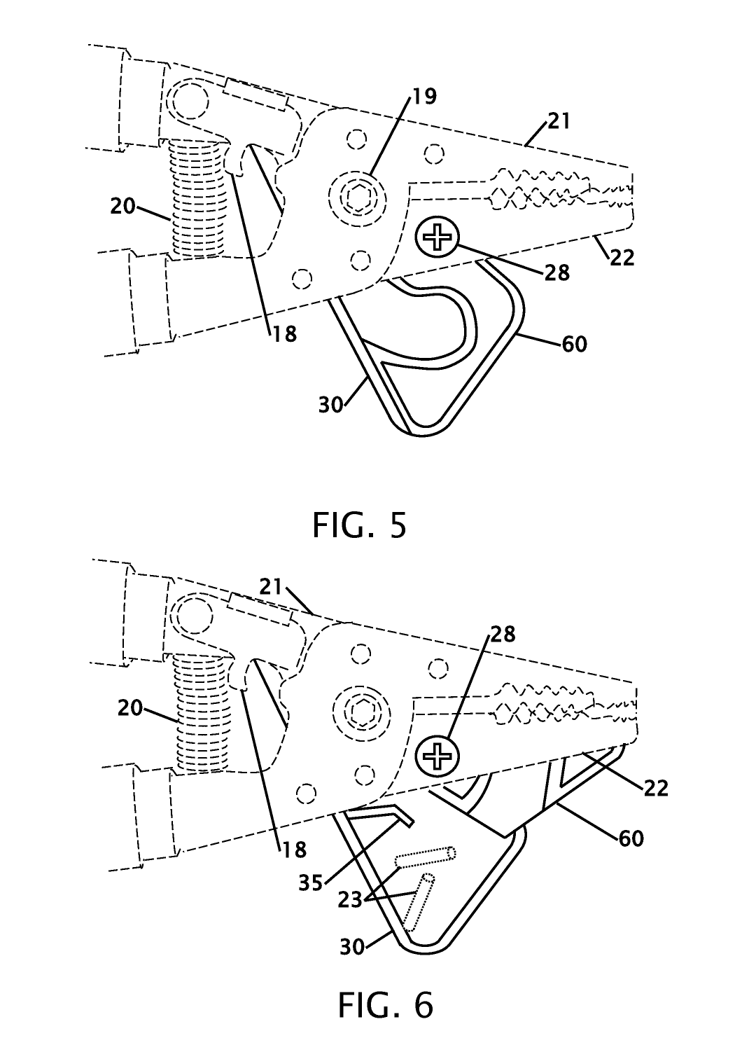

FIG. 6 shows a front side view of an insulation retainer for a wire stripper on a wire stripper tool with the door opened to empty stripped wire insulation pieces 23. From the previous figure the cover 60 is rotated on the screw 28 while the housing 30 remains essentially stationary. The lock 18 prevents the stripper from opening. This figure shows some of the internal features of the stripped insulation retainer 29. A trap wall 35 helps to prevent stripped insulation pieces 23 from falling back into the stripping area. The components of the stripped insulation retainer 29 are shown and described in more detail with other figures in this application where the parts are shown separately without the wire stripping tool obscuring the features.

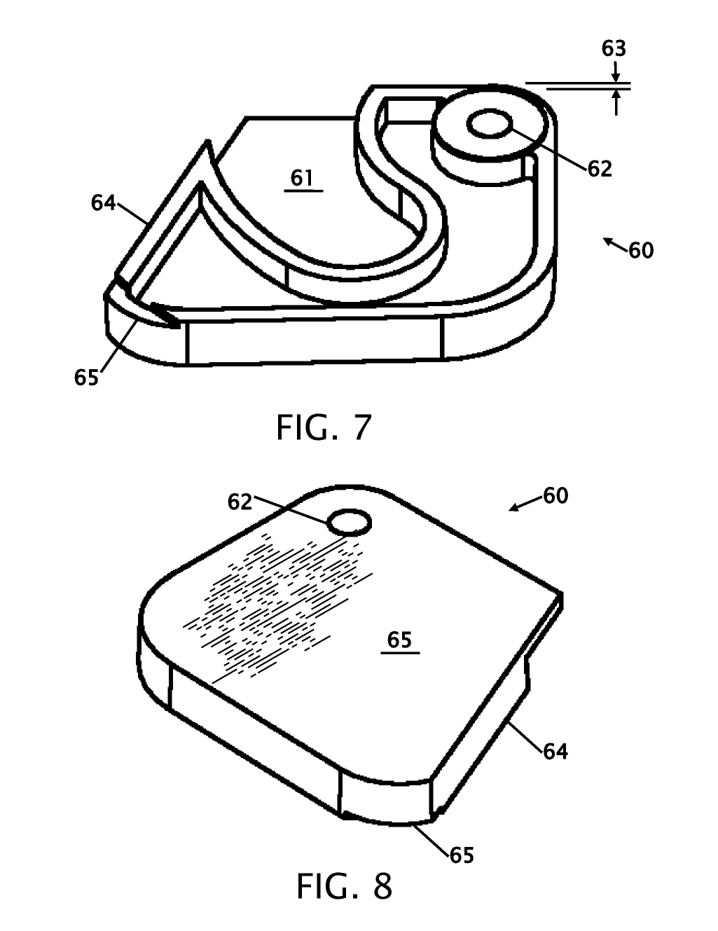

FIG. 7 shows an outside view of the door, and FIG. 8 shows an inside view of the door. The door 60 provides two essential functions. The first function is to cover the main housing to prevent stripped insulation from falling out of the housing in some orientations of the housing. The second feature is to provide a rotational stop for the jointed housings. This is accomplished by the recess 61. The recess 61 provides a track for the rivet or screw 19 (not shown in this figure) that joins the two parts 21, 22 of the wire stripper together. A rib 64 essentially surrounds the part 60. In FIG. 7 the hole 62 for the screw is shown. A slightly raised boss 63 provides a raised bearing surface for smoother rotation of the stripped insulation retainer 29. On one edge a slight notch 65 is located to provide clearance for the lock 18 (not shown in this figure) that extends beyond the height of the surface of the stripper. The flat surface 65 in FIG. 8 is in contact with surface 44 of the cover 30.

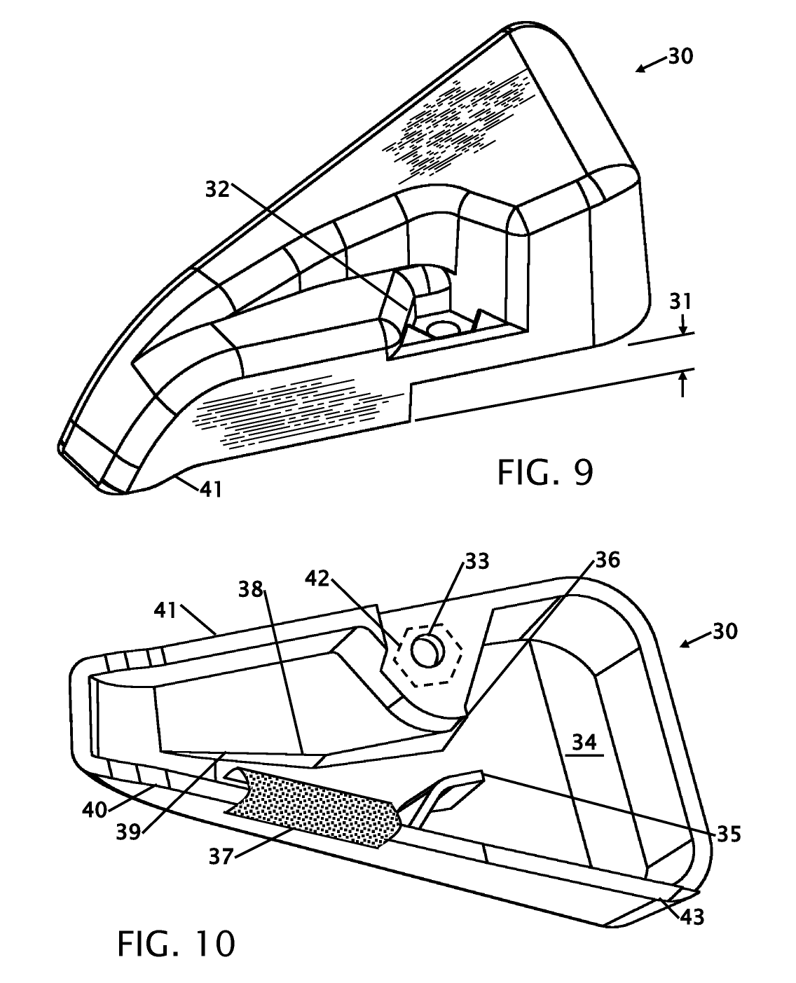

FIG. 9 shows an outside view of the cover 30 and FIG. 10 shows an inside view of the cover 30. The flat surface 44 mates with the flat surface of the door 60 in the gap 31 shown in these figures. While the inside geometry shows a particular configuration, the functions of these features remain essentially the same for the functionality of the stripped insulation retainer. From FIG. 9 the recess for the nut 32 is shown. The recess is configured to provide a pocket for the nut and also provides a fixed depth so the nut does not extend beyond the top surface of the cover 30. FIG. 9 also shows a contouring detail 41 that profiles the shape of the stripper tool 21 (shown in other figures herein). The opposing side 40 of the stripped insulation retainer has a contouring detail that matches the opposing side of the stripper tool 22 (shown in other figures herein).

The mounting hole 33 is visible in this figure with a boss 42 for retaining the nut in the housing 30. A one or a plurality of locating ribs 39 create the shelf for setting the strip length of the insulation. It is also contemplated that the outside wall could extend to this surface thereby eliminating these ribs. While this figure shows a plurality of ribs to maintain wall thickness, the ribs could be replaced with a wall. An internal rib 38 provides a guide for insulation. The rib 38 has a notch for clearance of the securing nut 19 (not shown in this figure) that holds the stripper together. This notch allows for rotation of the stripped insulation retainer on the stripper tool. This rib 38 terminates at a point 36 that reduces movement of stripped insulation out of the collection area 34. A second rib 35 provides a guide and trap to reduce stripped insulation from traveling from the collection reservoir 34 back into the stripping area. The reservoir is an enlarged open area where multiple pieces of stripped insulation can be stored until they are collectively emptied.

This embodiment further shows a seal 37 that provides a soft closure that reduces stripped insulation from falling out the sides of the housing. The rear corner 43 further has a notch 43 for lock 18 (not shown in this figure) clearance.

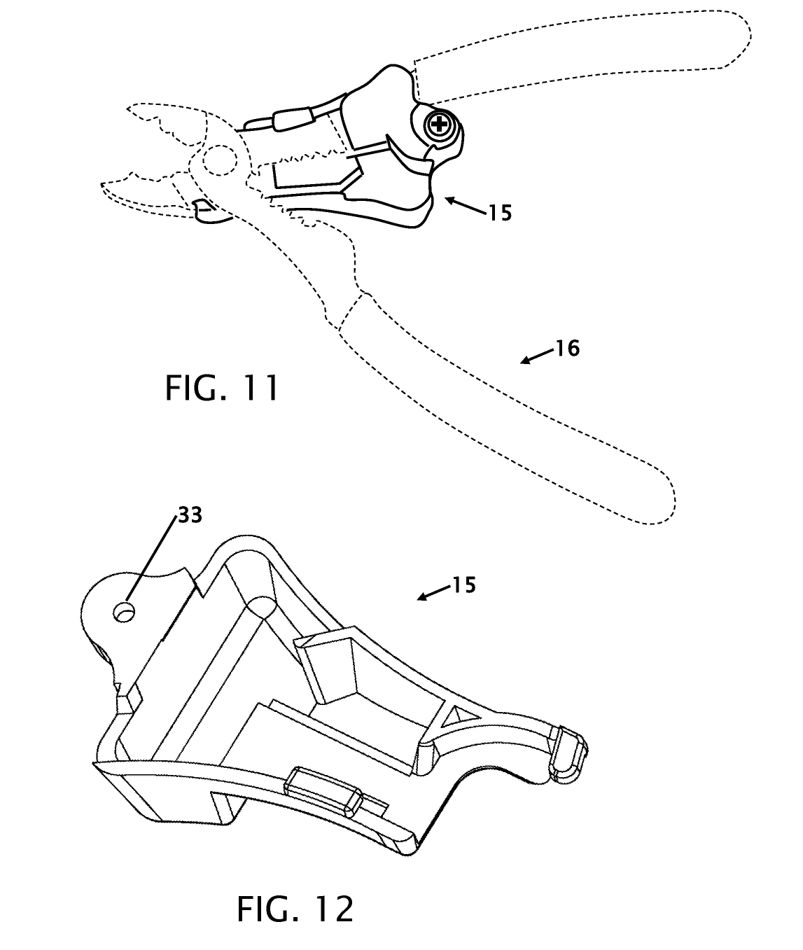

FIG. 11 shows a view of an alternate embodiment on a wire stripper tool 16 that strip wire from the middle of the tool and FIG. 12 shows a rotated view of alternate embodiment shown in FIG. 11 with the tool and the cover removed. This version 15 snaps around the tool 16. The mounting hole 33 allows the door to be rotated to empty stripped wire insulation from the internal cavity.

Thus, specific embodiments of an insulation retainer for a wire stripper have been disclosed. It should be apparent, however, to those skilled in the art that many more modifications besides those described are possible without departing from the inventive concepts herein. The inventive subject matter, therefore, is not to be restricted except in the spirit of the appended claims.

1. An insulation retainer for a wire stripper comprising:
a housing configured to adapt to a wire stripper;
said housing having a first surface configured to mate onto one planar side of said wire stripper;
said housing having a reservoir extending from said first surface;
said first surface having at least one opening configured to allow for insertion of an insulated wire through an opening of said wire stripper and into said reservoir, and
when said insulated wire is stripped said stripped insulation is retained in said reservoir.

2. The insulation retainer for a wire stripper according to claim 1 wherein said wire stripper accommodates insulated wires of different gauges.

3. The insulation retainer for a wire stripper according to claim 1 wherein said housing is temporally retainable on said wire stripper.

4. The insulation retainer for a wire stripper according to claim 1 further includes an operable door.

5. The insulation retainer for a wire stripper according to claim 4 wherein said operable door pivots on said housing.

6. The insulation retainer for a wire stripper according to claim 5 wherein said operable door is opened to empty insulation within said reservoir.

7. The insulation retainer for a wire stripper according to claim 1 wherein said housing further includes a ledge.

8. The insulation retainer for a wire stripper according to claim 7 wherein said ledge provides a finite strip length.

9. The insulation retainer for a wire stripper according to claim 1 wherein ledge is bypassable to strip a longer length of insulation.

10. The insulation retainer for a wire stripper according to claim 3 wherein said housing is retained using a pre-existing hole in said wire stripper.

11. The insulation retainer for a wire stripper according to claim 10 wherein said mounting is with a screw.

12. The insulation retainer for a wire stripper according to claim 11 wherein said screw further secures an operable door.

13. The insulation retainer for a wire stripper according to claim 3 wherein said retaining is with a fastener.

14. The insulation retainer for a wire stripper according to claim 3 wherein said retaining is with at least one magnet.

15. The insulation retainer for a wire stripper according to claim 1 wherein said housing at least partially wraps around said wire stripper.

16. The insulation retainer for a wire stripper according to claim 1 wherein said housing at least partially covers an end of said wire stripper.

17. The insulation retainer for a wire stripper according to claim 1 wherein said housing at least partially covers a central section of said wire stripper.

18. The insulation retainer for a wire stripper according to claim 1 wherein said housing is made of plastic.

19. The insulation retainer for a wire stripper according to claim 1 wherein said housing is printed, machined, cast or injection molded.

20. The insulation retainer for a wire stripper according to claim 1 wherein said insulation retained reduces foreign object debris.
